(19) United States
(12) Patent Application Publication
(10) Pub. No.: US 2026/0249290 A1
(43) Pub. Date: Aug. 27, 2026

(54) MICROFLUIDIC DEVICE WITH POSITIVE DISPLACEMENT PUMP

(71) Applicant: QUANTUMDX GROUP LIMITED, Newcastle Upon Tyne (GB)

(72) Inventors: Colin TOOMBS, Newcastle Upon Tyne (GB); Thomas WILLSHARE, Newcastle Upon Tyne (GB); Hojjat MADADI, Newcastle Upon Tyne (GB); Molly JOWSEY, Newcastle Upon Tyne (GB)

(21) Appl. No.: 19/650,107

(22) Filed: Apr. 16, 2026

Related U.S. Application Data
(62) Division of application No. 18/246,023, filed on Sep. 20, 2021.

(30) Foreign Application Priority Data
Sep. 21, 2020 (GB) 2014861.5

(51) Int. Cl. B01L 3/00; F04B 43/02

(52) U.S. Cl. CPC B01L 3/50273; B01L 3/502738; F04B 43/02; B01L 2200/027; B01L 2200/0684; B01L 2400/0481; B01L 2400/0633

(57) ABSTRACT

Disclosed herein is a microfluidic device for moving fluid through a microfluidic channel of the device. The device includes a microfluidic channel. The device further includes a positive displacement pump comprising a chamber connected to the microfluidic channel. The positive displacement pump is arranged such that when the positive displacement pump is actuated, fluid within the chamber is displaced into the microfluidic channel. The device further includes a fluid reservoir connected to the positive displacement pump to provide a source of fluid to re-fill the chamber of the positive displacement pump after the positive displacement pump has been actuated. The fluid reservoir is arranged such that fluid within the reservoir is sealed within the device.

### PRIORITY AND CROSS REFERENCE TO RELATED APPLICATIONS

This application is a divisional of U.S. application Ser. No. 18/246,023, filed Mar. 20, 2023, which was the U.S. National Stage Application under 35 U.S.C. § 371 of International Application No. PCT/GB2021/052429, filed Sep. 20, 2021, designating the U.S. and published in the English language as WO 2022/058749 A1 on Mar. 24, 2022, which claims the benefit of GB Patent Application No. GB 2014861.5, filed Sep. 21, 2020. Any and all applications for which a foreign or a domestic priority is claimed is/are identified in the Application Data Sheet filed herewith and is/are hereby incorporated by reference in their entirety under 37 C.F.R. § 1.57.

### TECHNICAL FIELD

The present invention relates to microfluidic devices and methods for moving fluid samples through microfluidic channels.

### BACKGROUND

Microfluidic devices, such as a microfluidic cassettes, can be used to perform chemical and/or biochemical analyses on a fluid sample provided by a patient at a point of care (POC). Such microfluidic devices, sometimes called a “lab on a chip” devices, are well known.

During operation of a microfluidic cassette, a fluid sample is moved along a microfluidic channel of the cassette through a series of “zones” where different processing steps are performed on the sample. Depending on the test being performed on the sample, the processing steps may involve, amongst other processes, heating or cooling the sample, combining the sample with one or more reagents, and/or passing the sample through a filter.

It is necessary to control the movement of a fluid sample through a microfluidic cassette so that the various processing steps can be correctly performed on the sample.

One known way of controlling the movement of a fluid sample through a microfluidic cassette is to connect an external pump (such as a syringe, pneumatic or peristaltic pump) to an opening on the cassette that provides access to the microfluidic channel. When operated, the external pump causes the sample to move through the cassette.

However, a disadvantage of using an external pump is that the cassette requires an opening to connect the external pump to the microfluidic channel. Having such an opening within the microfluidic channel has several disadvantages. First, it can lead to contamination of the fluid sample. This can reduce the accuracy of tests performed on the sample. Further, it can increase the risk that the fluid sample, or other potentially harmful chemicals within the cassette (such as reagents), leak out of the cassette. This may cause harm to users of the device. This may also cause contamination when a cassette comes into contact with fluid that has leaked out of another cassette, potentially leading to false-positive results if a diagnostic assay is performed on the cassette. Additionally, an external pump and its associated control components can be large and expensive.

It is an object of certain embodiments of the invention to obviate or mitigate one or more of the above described disadvantages.

### SUMMARY OF THE INVENTION

In accordance with a first aspect of the invention, there is provided a microfluidic device for moving fluid through a microfluidic channel of the device. The device comprising: a microfluidic channel, and a positive displacement pump comprising a chamber fluidically connected to the microfluidic channel. The positive displacement pump is arranged such that when the positive displacement pump is actuated, fluid within the chamber is displaced into the microfluidic channel. The device further comprises: a fluid reservoir fluidically connected to the chamber of the positive displacement pump to provide a source of fluid to re-fill the chamber after the positive displacement pump has been actuated. The fluid reservoir is arranged such that fluid within the reservoir is sealed within the device.

Optionally, the device further comprises a first valve arranged to selectively control the flow of fluid between the chamber of the positive displacement pump and the microfluidic channel, and a second valve arranged to selectively control the flow of fluid between the chamber of the positive displacement pump and the fluid reservoir.

Optionally, at least one of the first and second valves are externally actuatable.

Optionally, the fluid reservoir comprises a fluid storage chamber of the device.

Optionally, the fluid storage chamber is pre-pressurised to above atmospheric pressure prior to use.

Optionally, the fluid storage chamber is a waste chamber arranged to store waste liquid on the device.

Optionally, the device comprises a fluid loop providing a continuous fluid flow channel between the microfluidic channel and the positive displacement pump.

Optionally, the fluid storage chamber is connected such that it forms part of the continuous fluid flow channel.

Optionally, the fluid storage chamber comprises a first and a further fluid storage chamber port via which the fluid storage chamber is connected to the continuous fluid flow channel.

Optionally, the first and further fluid storage chamber ports extend above a base surface of the fluid storage chamber such that liquid can be stored within the fluid storage chamber below the level of the first and further fluid storage chamber ports.

Optionally, the fluid reservoir comprises an oversized portion of microfluidic channel adjacent to a port of the positive displacement pump.

Optionally, the positive displacement pump is a bellows pump.

Optionally, the chamber of the bellows pump is resiliently deformable.

Optionally, the microfluidic device is a microfluidic cassette.

In accordance with a second aspect of the invention, there is provided a method of moving fluid through a microfluidic channel of a microfluidic device. The method comprises the steps of: actuating a positive displacement pump of a microfluidic device such that fluid within a chamber of the positive displacement pump is displaced into a microfluidic channel thereby causing fluid to move through the microfluidic channel; and re-filling the chamber of the positive displacement pump from a source of fluid provided by a fluid reservoir of the device, the fluid reservoir arranged such that fluid within the reservoir is sealed within the device.

Optionally, the device further comprises a first valve arranged to selectively control the flow of fluid between the chamber of the positive displacement pump and the microfluidic channel, and a second valve arranged to selectively control the flow of fluid between the chamber of the positive displacement pump and the fluid reservoir.

Optionally, the method further comprises: closing the second valve and opening the first valve prior to actuating the positive displacement pump; and closing the first valve and opening the second valve prior to re-filling the chamber.

Advantageously, in accordance with embodiments of the invention, there is provided an effective way of moving a fluid sample through a microfluidic device such as a microfluidic cassette.

Advantageously, embodiments of the invention provide a microfluidic device that includes an on-board fluid reservoir that provides a source of fluid that can be used to re-fill (also referred to herein as “re-inflate”) an on-board positive displacement pump such as a bellows pump. The fluid reservoir is fluidically sealed to prevent fluid within the reservoir from escaping from the device.

Advantageously, providing a fluid reservoir on the device means that the positive displacement pump can have a reduced volume because a single “stroke” or “compression” of the pump does not need to be able to move a fluid sample all of the way through the cassette. Instead, after being actuated, the positive displacement pump can be re-filled one or more times using fluid stored in the fluid reservoir. In this way, the pumping volume of the positive displacement pump can be less than the pumping volume required to move a fluid sample through a cassette. The device can include a valve arrangement to selectively control fluid flow through the device.

Advantageously, providing a reduced volume positive displacement pump can lead to a smaller overall ‘footprint’ of the device. This has several advantages including decreasing the cost of manufacturing the device.

Advantageously, embodiments of the invention provide a device that is fluidically sealed. Advantageously, an opening for connecting an external pump to the device does not need to be provided. Advantageously, this can help prevent contamination of a sample being processed within the device. Additionally, this can prevent a user of the device from coming into contact with harmful substances inside the device such as reagents, a biological fluid sample, or amplified DNA.

Advantageously, embodiments of the invention provide a device that includes an on-board positive displacement pump and fluid reservoir. That is, a positive displacement pump and fluid reservoir are integrated onto the device. This can reduce the overall size, cost and complexity associated with having an external pump.

Advantageously, in accordance with certain embodiments of the invention, a portion of an existing fluid chamber on a microfluidic device, such as waste liquid chamber, can be used as a fluid reservoir to provide a source of fluid to re-fill the positive displacement pump. Advantageously, this can further reduce the footprint of the microfluidic device.

Advantageously, in accordance with certain embodiments of the invention, the fluid chamber can be connected within a continuous fluid flow circuit with the positive displacement pump. This can further improve the ease with which a fluid sample can be moved through the device because in addition to generating positive pressure behind the fluid sample, actuating the positive displacement pump also generates negative pressure in front of the fluid sample.

Advantageously, in accordance with certain embodiments of the invention, the positive displacement pump is resilient such that it is mechanically biased to return to an initial pre-actuation position. Advantageously, this can enable negative pressure to be generated in a portion of microfluidic channel. Generating negative pressure in this way can be particularly useful for many applications in microfluidics such as filter drying in DNA extraction processes.

Advantageously, in accordance with certain embodiments of the invention, the device can provide an accurate way of controlling fluid flow through a microfluidic channel, which can be useful, for example, for fluid metering.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 is a simplified schematic diagram of a microfluidic device in accordance with certain embodiments of the invention;

FIG. 2 is a simplified schematic diagram showing a further microfluidic device in accordance with certain embodiments of the invention;

FIG. 3 is a simplified schematic diagram showing a further microfluidic device in accordance with certain embodiments of the invention;

FIGS. 4A-4F are simplified schematic diagrams showing the microfluidic device of FIG. 3 in use;

FIG. 5 is a diagram showing a cross section of a fluid storage chamber in accordance with certain embodiments of the invention;

FIG. 6 is a diagram showing a cross sectional view of a valve that can be used in a microfluidic device in accordance with certain embodiments of the invention;

FIGS. 7A and 7B provide further cross-sectional diagrams of the valve of FIG. 6 in use;

FIG. 8 is a diagram showing a bellows pump that can be used in a microfluidic device in accordance with certain embodiments of the invention; and

FIG. 9 is a simplified schematic diagram showing a further microfluidic device in accordance with certain embodiments of the invention.

### DETAILED DESCRIPTION

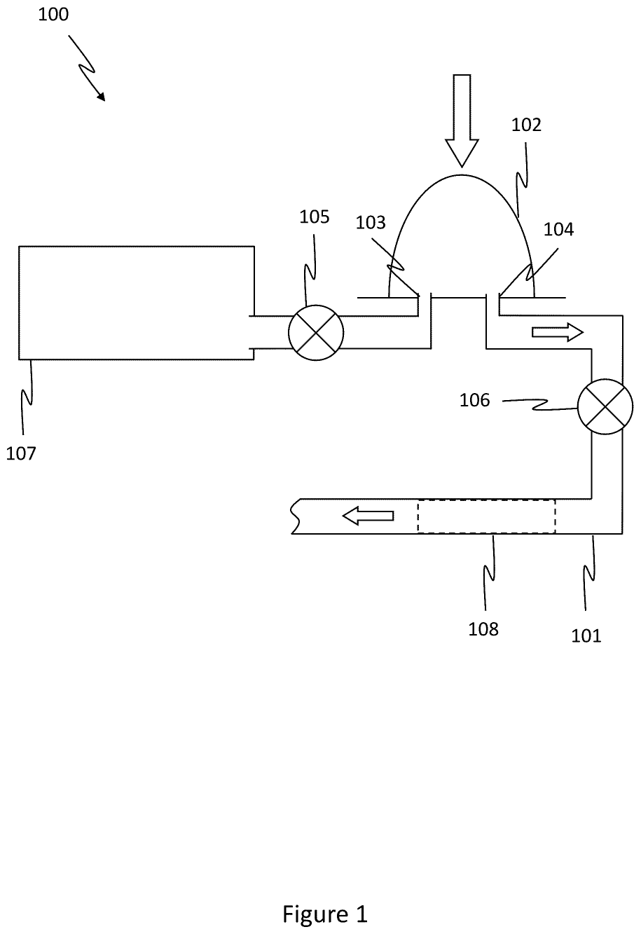

FIG. 1 is a simplified schematic diagram of a microfluidic device in accordance with certain embodiments of the invention.

The microfluidic device 100 is a microfluidic cassette (of which only a portion is shown). The cassette can be used to perform on-cassette diagnostic processing on a liquid biological sample such as a blood, plasma or urine sample obtained from a human patient, typically in combination with a benchtop or portable analyser (a “host device”) which may house elements such as imaging apparatus, power, control circuits and actuators. The diagnostic processing can involve amplification of deoxyribonucleic acid (DNA) in the sample by polymerase chain reaction (PCR).

Throughout this document reference to “microfluidic” means with at least one dimension less than 1 millimetre and/or able to deal with microlitre or less portions of fluid.

The cassette is arranged to be inserted into a host device for processing. The host device typically includes instruments that interact with the cassette, such as mechanical actuators, heating/cooling components and imaging components, to cause the cassette to perform diagnostic processing on a sample. The cassette is typically a single use component and is disposed of after processing has been performed on a sample contained in the cassette.

The processing of a sample (also referred to herein as an “assay”) is typically carried out by allowing the sample to interact with reagents in one or more processing steps that are performed in channels and/or chambers of the device 100. The processing steps are typically performed at times and temperatures that cause a detectable product to be formed that indicates the presence or absence of an analyte in the sample.

The cassette includes a microfluidic channel 101. The channel 101 is an enclosed fluid flow channel that is arranged to allow a liquid biological sample (and/or reagents) to flow through one or more “zones” of the cassette where processing activities are performed on the sample.

For simplicity, portion of a single schematic microfluidic channel is shown in FIG. 1. However, it will be understood that in certain embodiments, the device 100 includes various further components including further microfluidic channels, valves, chambers and/or branches etc. as required to carry out an assay. Such further components can be used to allow mixing, washing, removal and other actions to occur according to the needs of a particular assay.

It will further be understood that a range of suitable lengths and cross-sectional shapes of microfluidic channel can be used to allow for the desired transport and processing of a sample and/or reagents.

The device 100 includes a positive displacement pump. In this embodiment, the positive displacement pump is a bellows pump 102.

It will be understood that a positive displacement pump is a device that is arranged to cause a fluid to move by displacing a volume of fluid from a chamber.

The bellows pump 102 includes a resiliently deformable chamber. The bellows pump 102 includes first and second ports 103 104. The first and second ports 103 104 enable fluid communication between the bellows pump 102 and other components of the device 100. In the primary direction of operation of the bellows pump 102 where positive pressure is generated in the microfluidic channel 101 to cause fluid to move along the channel 101, the second port 104 acts as a fluid outlet via which fluid is forced out of the chamber of the bellows pump 102 and along the microfluidic channel 101. The first port 103 acts as a fluid inlet for re-inflating the chamber of the bellows pump 102 from the fluid reservoir after the bellows pump 102 has been actuated.

The bellows pump 102 is arranged to be actuated by applying a mechanical force to deform the deformable chamber. Whilst this can be done manually, it is preferred that the cassette is inserted into a host device which has automated actuators which mate with, or apply appropriate external pressure to the outer surface of, said bellows pump 102. This reduces the volume of the deformable chamber. Reducing the volume of the deformable chamber increases the pressure of fluid (typically air) inside the deformable chamber. This increase in pressure can be used to force fluid out of the second port 104 and along the microfluidic channel 101.

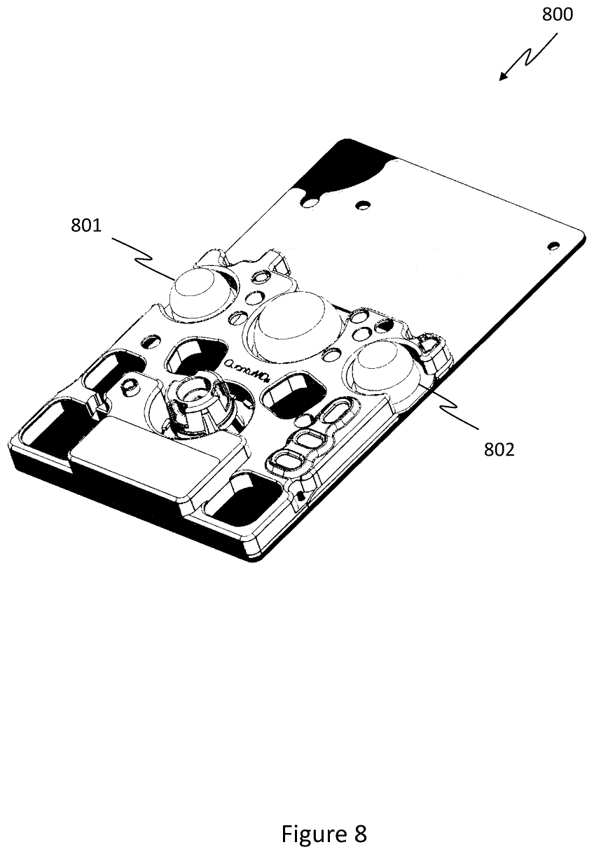

An example of a bellows pump arrangement that can be used in accordance with certain embodiments of the invention is shown in FIG. 8.

The device 100 includes first and second valves 105 106. In certain embodiments, the valves 105 106 form part of the positive displacement pump 102.

The first valve 105 is located adjacent to the first port 103 to selectively control the flow of fluid between the deformable chamber and the fluid reservoir (via the first port 103). The second valve 106 is located adjacent to the second port 104 to selectively control the flow of fluid between the deformable chamber and the microfluidic channel 101 (via the second port 104).

In certain embodiments, the valves 105 106 can be externally actuated, for example by applying a mechanical force to the valves 105 106 to move the valves 105 106 from an open to a closed configuration.

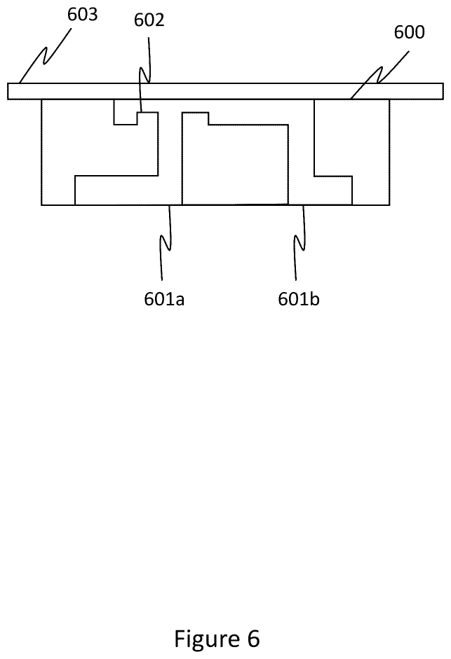

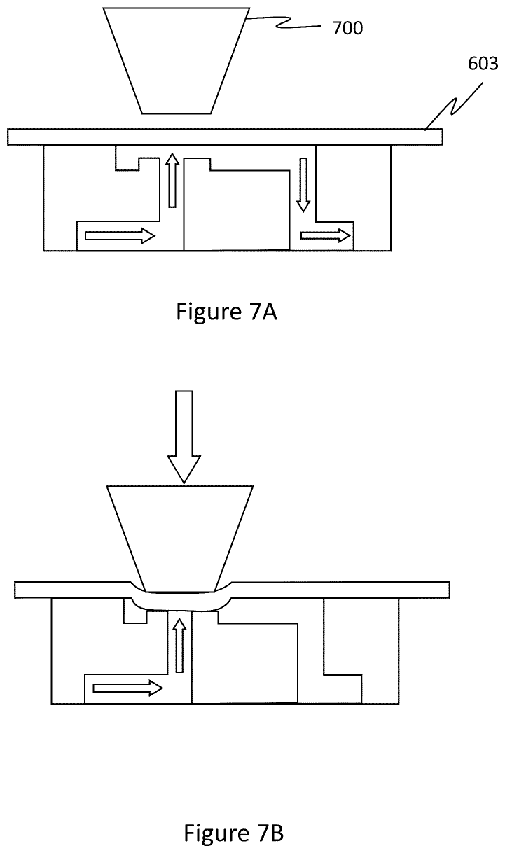

An example of a valve arrangement can be used in accordance with certain embodiments of the invention is shown in FIGS. 6 and 7A-7B.

The device 100 includes a fluid reservoir 107. The fluid reservoir 107 stores a volume of fluid (typically air) within the device 100. The fluid reservoir 107 is fluidically sealed such that fluid inside the fluid reservoir 107 is prevented from leaking out of the device 100. In this way, the fluid reservoir 107 stores a volume of fluid that is fluidically sealed from the local environment of the device 100.

The fluid reservoir 107 is connected to the first port 103 of the bellows pump 102 (via the first valve 105) to provide a source of fluid to the bellows pump 102. As described in more detail below, after the bellows pump 102 has been actuated, the first valve 105 can be opened, the second valve 106 can be closed, and fluid from the fluid reservoir 107 can be used to re-fill the bellows pump 102 by providing fluid to the deformable chamber.

In this embodiment, the fluid reservoir 107 is a fluid storage chamber of the device 100. The fluid storage chamber provides a dedicated volume of fluid that can be used as a source of fluid to re-inflate the chamber of the bellows pump 102 after each actuation of the bellows pump 102.

In certain embodiments, the fluid storage chamber is pre-pressurised prior to the device 100 being used such that before the first time the bellows pump 102 is actuated, fluid within the fluid storage chamber is at above atmospheric pressure. This increases the amount of fluid that is stored in the fluid storage chamber, which increases the capacity of the fluid storage chamber to re-inflate the bellows pump 102. In such embodiments, the pre-pressurised fluid storage chamber is fluidically sealed to prevent pressurised fluid from leaving the chamber prior to use. In certain embodiments, the first valve 105 can be closed prior to use to fluidically seal the pre-pressurised fluid storage chamber.

Alternatively, or additionally, the fluid storage chamber can be composed of a deformable material. In such embodiments, as fluid within the fluid storage chamber is used up to re-inflate the bellows pump 102, the fluid storage chamber can deform to reduce the inner volume of the fluid storage chamber. This can help prevent a region of relative “low” pressure building up within the fluid storage chamber.

The device 100 will now be described in use. As shown in FIG. 1, a fluid sample 108, such as a liquid biological specimen, is located within the microfluidic channel 101.

The first valve 105 is closed and the second valve 106 is opened.

Next, a mechanical force is applied to the bellows pump 102. This is shown in FIG. 1.

Actuating the bellows pump 102 reduces the volume of the deformable chamber. This causes fluid inside the bellows pump 102 to be expelled from the second port 104. This forces the fluid sample 108 along the microfluidic channel 101.

Next, the second valve 106 is closed and the first valve 105 is opened. The mechanical force is removed from the bellows pump 102 to allow the deformable chamber to return to the original volume as the deformable chamber is filled with fluid from the fluid storage chamber. This causes the pressure to equalise between the deformable chamber and the fluid storage chamber.

Advantageously, the above-mentioned steps can then be repeated to actuate the bellows pump one or more further times to continue to move the fluid sample through the microfluidic channel, depending on the requirements for performing particular processing on a sample.

In this way, the fluid reservoir 107 (in this embodiment, a fluid storage chamber) provides a source of fluid to “re-charge” (also referred to herein as “re-fill” or “re-inflate”) the bellows pump 102 after each actuation. This means that the volume of the bellows pump 102, and therefore also its footprint on the cassette, can be made smaller because a single actuation of the bellows pump 102 does not need to be capable of moving a fluid sample through the entire microfluidic channel 101.

It will be understood that in a typical sample processing process, a fluid sample will be moved in multiple separate steps through a microfluidic channel, through multiple zones, based on a pre-determined assay process. Such movement of the sample can be performed by suitable selective actuation of the bellows pump.

Further, certain steps can involve the sample 108 being moved in the opposite direction around the microfluidic channel 101 to that described above. It will be understood that this can be achieved by actuating the bellows pump 102 with the first valve 105 open and the second valve 106 closed.

While embodiments of the invention are described with reference to a bellows pump, it will be understood that in certain embodiments other types of positive displacement pump, such as a syringe pump, micro-syringe pump or diaphragm pump, can be used.

A syringe pump includes a piston movable within a syringe chamber. When a syringe pump is actuated, a mechanical force applied to the pump causes the piston to move within the syringe chamber, thereby increasing the pressure.

In certain embodiments, the fluid reservoir 107 comprises an oversized region of microfluidic channel that is connected adjacent to the first port 103.

It will be understood that while certain embodiments are described in the context of a diagnostic assay being performed on a biological sample, in certain embodiments, the microfluidic device can perform other types of assay, such as biochemical assays.

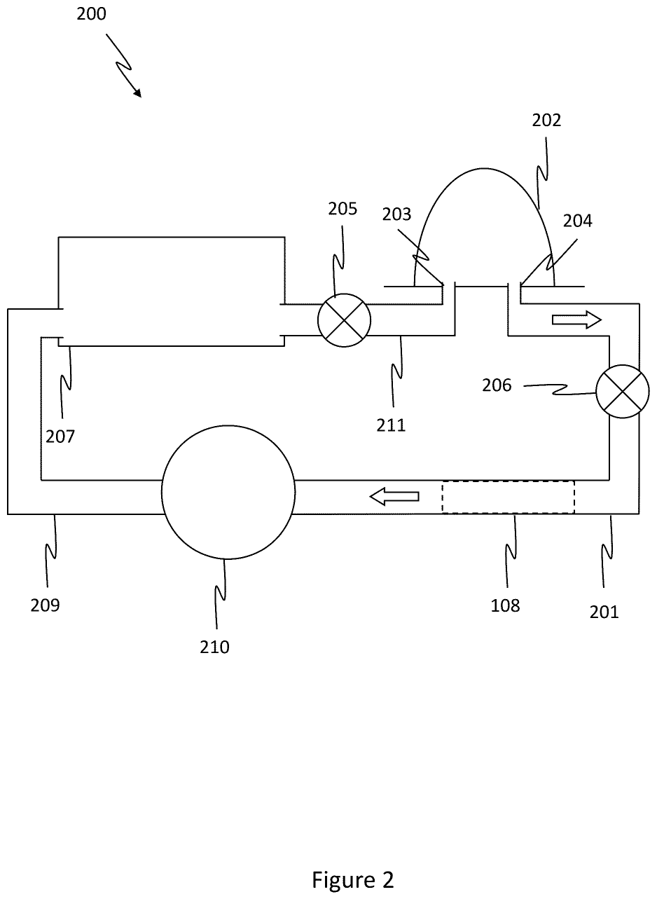

FIG. 2 is a simplified schematic diagram showing a further microfluidic device in accordance with certain embodiments of the invention. The device substantially corresponds with the device described with reference to FIG. 1 except as otherwise described and depicted.

The device 200 includes a microfluidic channel 201, a positive displacement pump 202, first and second ports 203 204, and first and second valves 205 206 for controlling the flow of fluid through the first and second ports 203 204. The device 200 also includes a fluid reservoir. Similar to the device described with reference to FIG. 1, the fluid reservoir is a fluid storage chamber 207 of the device 200.

A schematic sample processing region 210 is also shown in FIG. 2. It will be understood that the sample processing region 210 can take any suitable arrangement depending on the assay that is being performed by the device 200. For example, the sample processing region 210 can include one or more filters that are used to separate portions of a sample, and/or heating/cooling regions of the cassette.

The device 200 includes a fluid loop provided by a continuous fluid flow channel that extends between the first and second port 203 204 of the positive displacement pump 202. A fluid path is provided along the length of the continuous fluid flow channel.

In this embodiment, the fluid loop comprises: a first portion of microfluidic channel 201 that connects the second port 204 and the sample processing region 210, the sample processing region 210 itself, a second portion of microfluidic channel 209 that connects the sample processing region 210 and the fluid storage chamber 207, the fluid storage chamber itself 207, and a third portion 211 of microfluidic channel that connects the fluid storage chamber 207 and the first port 203.

It will however be understood that various other suitable configurations for the fluid loop can be used, depending on the configuration of the device and the assay (or assays) to be performed.

In this way, the fluid storage chamber 207, which acts as a fluid reservoir to provide a source of fluid to re-fill the positive displacement pump 202, forms part of the continuous fluid loop with the positive displacement pump 202.

Advantageously, this arrangement can help prevent back pressure building up in the fluid storage chamber 207 as the positive displacement pump 202 is repeatedly actuated. This is because each actuation of the positive displacement pump 202 causes the pressure to substantially or partially equalise around the fluid loop. Advantageously, this means that the capacity for the positive displacement pump 202 to be repeatedly actuated is increased.

In certain embodiments, the total volume of the continuous fluid loop is approximately 11 ml.

In certain embodiments, the total volume of the fluid storage chamber 207 is approximately 5 mL.

In certain embodiments, the total volume of the chamber of the positive displacement pump 202 is approximately 4 mL.

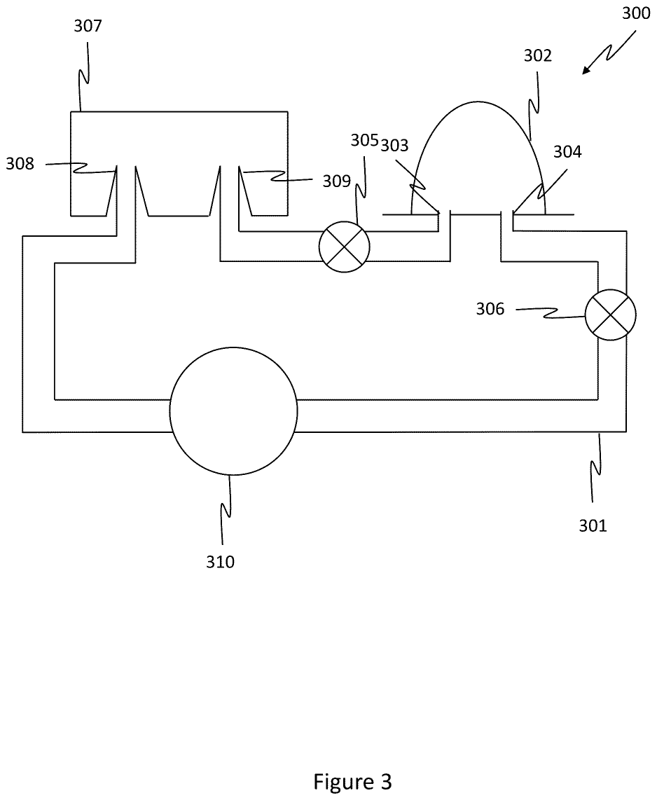

FIG. 3 is a simplified schematic diagram showing a further microfluidic device in accordance with certain embodiments of the invention. The device substantially corresponds with the device described with reference to FIG. 2 except as otherwise described and depicted.

The device 300 includes a microfluidic channel 301, a positive displacement pump 302, first and second ports 303 304, and first and second valves 305 306 for controlling the flow of fluid through the first and second ports 303 304. The device 300 also includes a fluid storage chamber. A sample processing region 310 is also shown in FIG. 3.

In this embodiment, the fluid storage chamber is a waste storage chamber 307 of the device 300. The waste chamber 307 is arranged to store waste liquid on the device 300. Such waste liquid is typically generated during operation of a microfluidic cassette and can include a processed portion of sample, which may be mixed with one or more reagents.

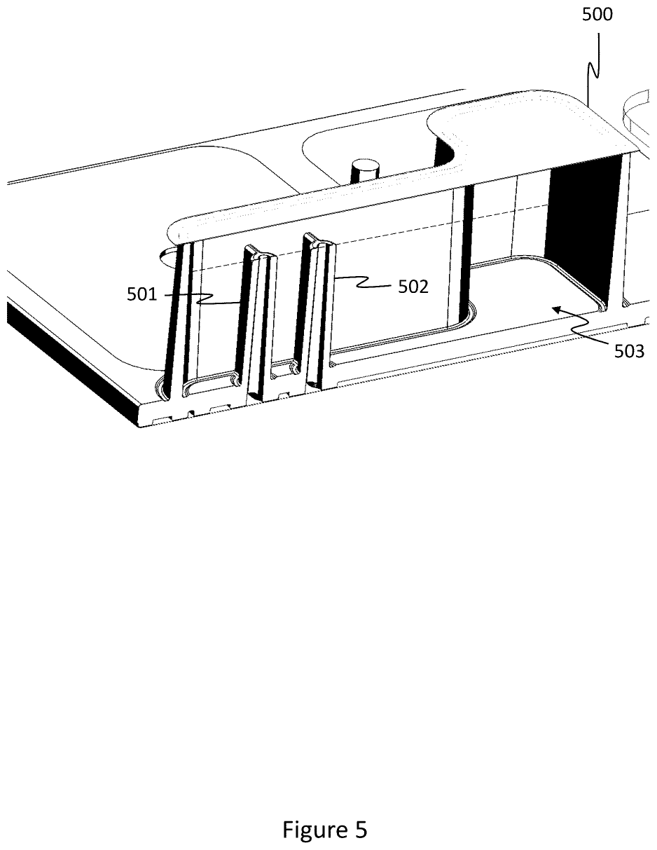

An example of a suitable arrangement for the waste storage chamber is shown in FIG. 5.

The waste storage chamber 307 includes a first port 308 and a second port 309. The first and second ports 308 309 enable fluid communication between the waste storage chamber 307 and other components of the device 300.

The waste storage chamber 307 is connected, via the first and second ports 308 309, such that it forms part of the continuous fluid flow channel with the positive displacement pump 302. When connected in this way, a fluid communication passageway is provided from the positive displacement pump 302, around the microfluidic channel 301, through the waste storage chamber 307 and back to the positive displacement pump 302.

The first and second ports 308 309 extend within the waste storage chamber 301 above the level of a base surface of the chamber 307 (when the device 300 is oriented for use) such that liquid can be stored within the fluid storage chamber 307 below the level of the first and second ports 308 309, and gas (typically air) can be stored in the remainder of the waste storage chamber 301 above the liquid.

In this way, in addition to storing waste liquid, the waste storage chamber 307 is arranged to act as a fluid reservoir by storing a volume of fluid (typically air) that can be used to re-charge the positive displacement pump 302.

The waste storage chamber 307 therefore provides a dual storage capability. This can reduce the overall size of the device 300. This also means that a separate dedicated fluid storage chamber for re-charging the positive displacement pump is not required.

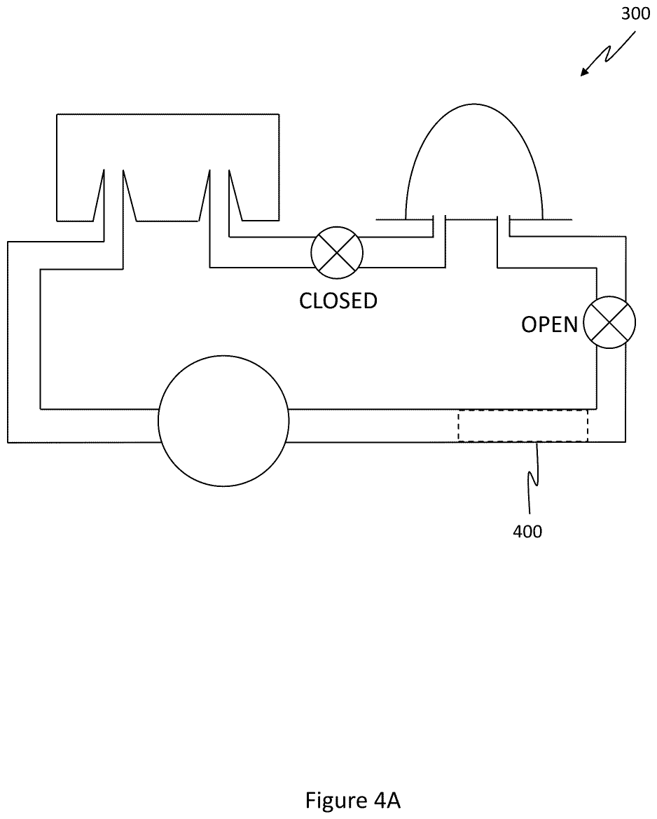

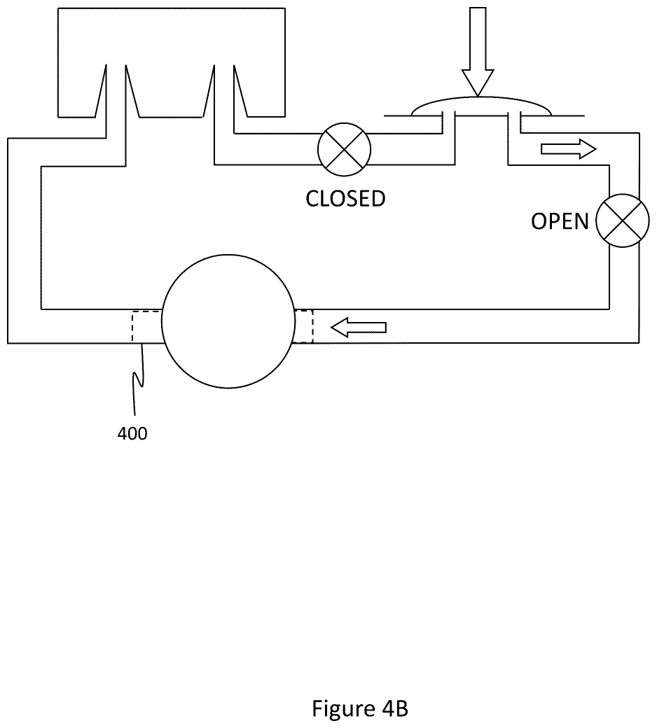

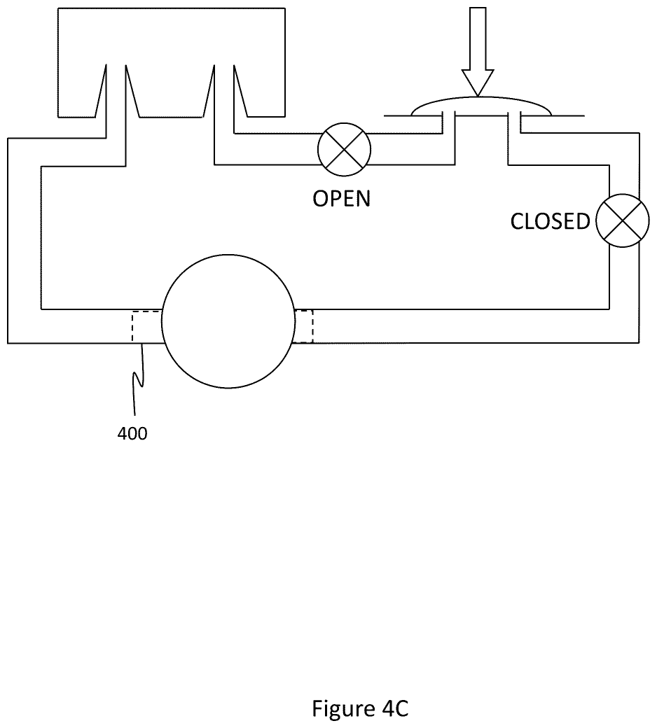

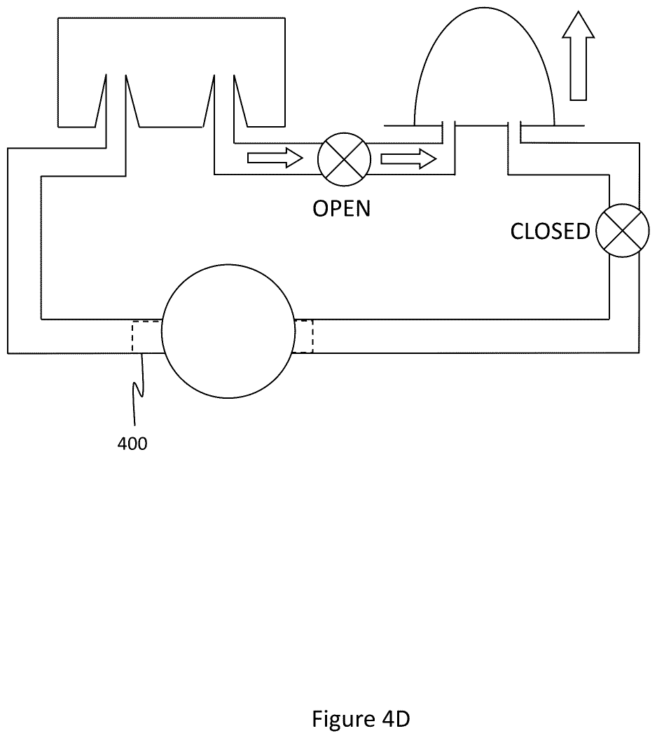

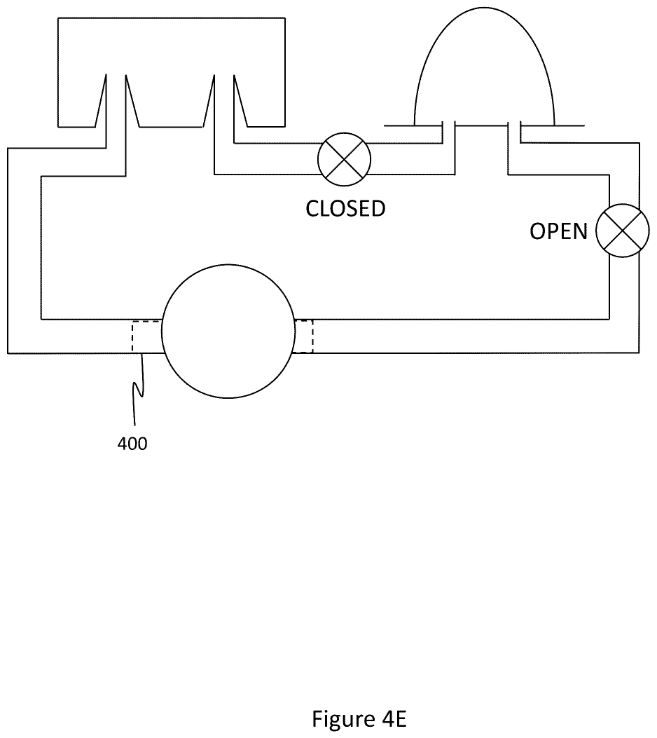

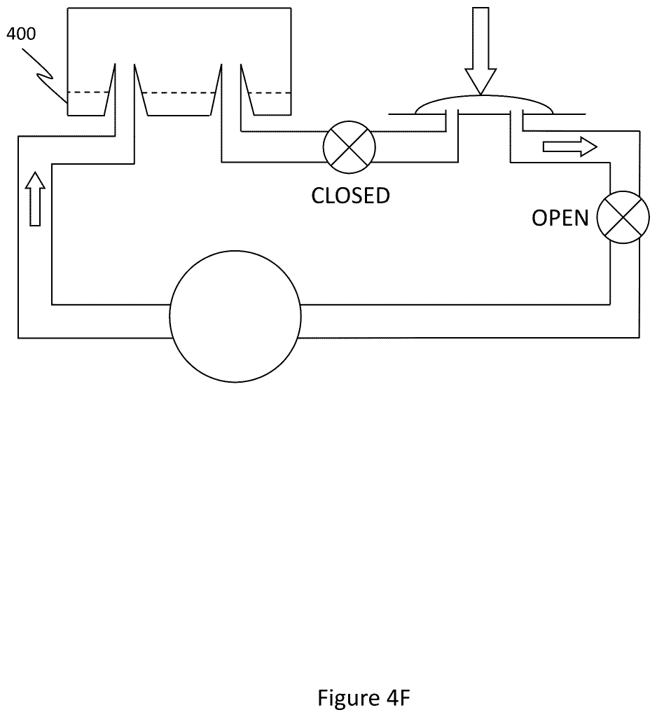

The device 300 will now be described in use with reference to FIGS. 4A to 4F as a fluid sample is moved through a microfluidic channel.

FIGS. 4A-4F are simplified schematic diagrams showing the microfluidic device of FIG. 3 in use. For clarity, certain reference signs have been omitted from FIGS. 4A-4F.

Typically, the actions of actuating the positive displacement pump and opening and closing the valves are performed automatically by mechanical actuators of a host device based on a pre-programmed sequence.

FIG. 4A shows the microfluidic device 300 prior to use.

As shown in FIG. 4A, initially the first valve is closed and the second valve is open. A biological sample 400 is present in the microfluidic channel.

Next, as shown in FIG. 4B, the positive displacement pump is actuated. A mechanical force is applied to the positive displacement pump which reduces the volume of the pump chamber thereby causing the pressure inside the chamber to increase and forcing fluid inside the chamber out of the second port and into the microfluidic channel. This forces the sample 400 around the microfluidic channel.

Next, as shown in FIG. 4C, the first valve is opened and the second valve is closed. In this configuration, the chamber of the positive displacement pump is ready to be re-filled.

Next, as shown in FIG. 4D, the mechanical force is removed from the positive displacement pump. Fluid is drawn into the chamber of the positive displacement pump from the fluid reservoir as the chamber is re-filled and returns to the previous (i.e. unactuated) volume.

Next, as shown in FIG. 4E, the first valve is closed and the second valve is opened such that the positive displacement pump and valves are returned to the starting configuration depicted in FIG. 4A.

The steps of FIGS. 4B to 4E can then be repeated one or more further times to move the sample around the microfluidic channel.

FIG. 4F shows one further actuation of the positive displacement pump. A mechanical force is again applied to the positive displacement pump. The pressure generated by actuating the positive displacement pump causes the fluid sample 400 to move through the microfluidic channel and into the waste chamber.

Once in the waste chamber, the fluid sample 400 is stored in the lower portion of the chamber.

It will be understood that, if necessary, the fluid sample 400 can be moved in the opposite direction around the microfluidic channel by reversing the operation of the valves (i.e. actuating the positive displacement pump with the first valve open and the second valve closed).

In certain embodiments, the device 300 is provided with one or more sensors that can detect the presence or absence of liquid at points along the continuous fluid flow channel. For example, a liquid sensor can be located adjacent to the first port of the waste chamber. In such embodiments, the presence or absence of liquid can be used to determine the location of a fluid sample within the device. This information can be used by a host device such as an analyser to determine whether to continue to actuate the positive displacement pump, for example in a condition where not all of the fluid sample has been moved into the waste chamber.

FIG. 5 is a diagram showing a cross section of a fluid storage chamber in accordance with certain embodiments of the invention.

The fluid storage chamber 500 is a waste chamber arranged to store waste liquid on a microfluidic cassette. Such waste liquid is typically generated during operation of a microfluidic cassette and can include a processed portion of biological sample, which may be mixed with one or more reagents.

The fluid storage chamber 500 includes first and second ports 501 502. The ports 501 502 extend into the fluid storage chamber 500 such that the port openings are located above the base surface of the fluid storage chamber 500. In this way, in use, waste liquid can enter the fluid storage chamber (typically via the first port 501) and be stored in a liquid storage region 503 of the fluid storage chamber 500 which is formed below the level of the port openings.

Due to the position of the port openings above the level of liquid in the fluid storage chamber, a fluid path is provided between the first and second ports 501 502. In use when the fluid storage chamber forms part of a continuous fluid loop with the positive displacement pump, the fluid path provides a path for gasses (typically air) to be exchanged between the first and second ports 501 502. This means that negative pressure does not continue to build up behind the positive displacement pump with every time the positive displacement pump is actuated.

In this embodiment, the ports 501 502 are shaped as hollow spikes. It will however be understood that different port shapes and arrangements could be used.

FIG. 6 is a diagram showing a cross sectional view of a valve that can be used in a microfluidic device in accordance with certain embodiments of the invention.

The valve is formed in a portion of microfluidic cassette body 600 along a microfluidic channel of the cassette.

The valve includes an inlet 601a and an outlet 601b that are in fluid communication with the microfluidic channel.

The valve includes a valve seat 602. The valve seat 602 is a raised portion of material adjacent to the inlet 601a.

The valve also includes flexible membrane layer 603. The membrane layer 603 is secured to the microfluidic cassette body 600 to provide a fluid tight seal that prevents fluid from leaking out from the microfluidic channel of the cassette adjacent to the valve.

The membrane layer 603 overlies the valve seat 602 and is arranged to be deflected by an external valve actuator to make contact with the valve seat 602 to create a fluid tight seal between the valve seat 602 and the membrane layer 603.

Such an external valve actuator is typically a mechanical actuator of a host device into which a microfluidic cassette incorporating the valve has been inserted.

In certain embodiments the membrane layer 603 includes a surface indentation at a position that overlies the valve seat 602 where an external valve actuator makes contact with the membrane layer 603.

In certain embodiments, the membrane layer 603 is composed of a thermoplastic elastomer (TPE) material.

FIGS. 7A and 7B provide further cross-sectional diagrams of the valve of FIG. 6 in use.

FIG. 7A shows the valve in an open position. FIG. 7A also shows a mechanical valve actuator 700. In FIG. 7A, the valve actuator 700 is not in contact with the membrane layer 603 so that a fluid flow passageway through the valve is provided.

FIG. 7B shows the valve in a closed position. In FIG. 7B, the valve actuator 700 has made contact with the membrane layer 603 causing the membrane layer 603 to deflect and thereby seal against the valve seat. In the closed position, fluid is prevented from flowing through the valve.

FIG. 8 is a diagram showing a portion of a microfluidic cassette that includes a plurality of bellows pumps in accordance with certain embodiments of the invention.

The microfluidic cassette 800 includes a bellows pump 801. The bellows pump 801 is used to drive fluid around a fluid circuit of the cassette 800. The cassette shown in FIG. 8 also includes a second bellows pump 802 which substantially corresponds with the first bellows pump 801. The second bellows pump 802 can be provided to drive fluid around a different fluid circuit of the cassette 800.

The bellows pump 801 is fluidically connected to a respective microfluidic circuit via an inlet and outlet port.

The bellows pump 801 includes a substantially hemispherical chamber. The chamber is arranged to be deformed by a mechanical actuator to reduce the volume of the chamber. This causes fluid inside the chamber (typically air) to be forced out of the chamber, thereby causing fluid to flow around the microfluidic channel of the cassette 800.

The bellows pump 801 chamber is composed of a resiliently deformable material. The chamber is resiliently biased to return to an unactuated shape (and volume) after actuation. It will be understood that in certain embodiments, other suitable shapes of bellows pumps can be used.

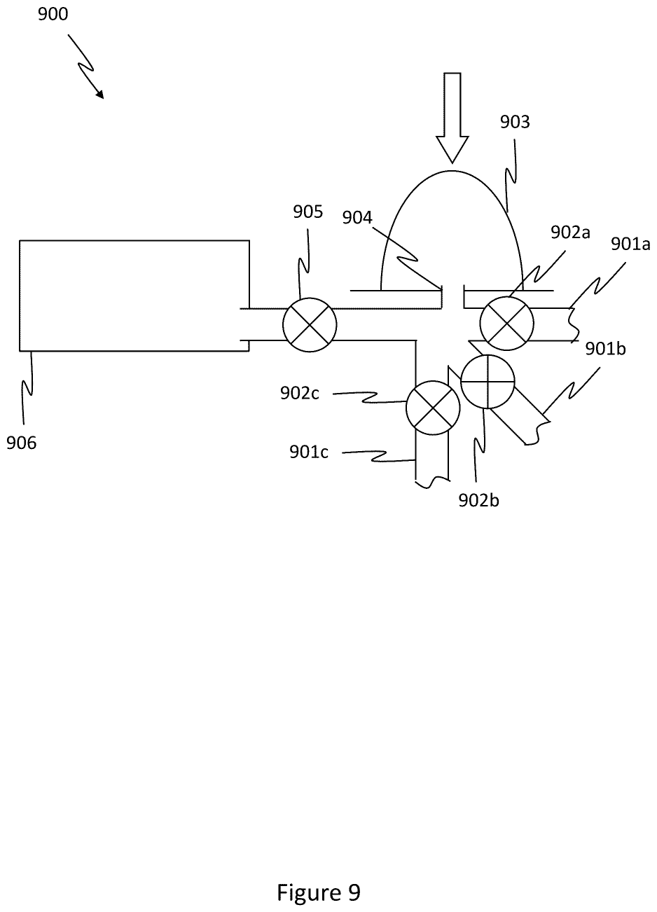

FIG. 9 is a simplified schematic diagram showing a further microfluidic device in accordance with certain embodiments of the invention.

The device 900 substantially corresponds with the device described with reference to FIG. 1 except as otherwise described and depicted.

The device 900 includes a positive displacement pump 903, a first port 904, a fluid reservoir valve 905, and a fluid reservoir 906. The fluid reservoir 906 is a fluid storage chamber of the device 900.

The device 900 differs from the device shown in FIG. 1 in that it includes more than one microfluidic channel fluidically connected to the positive displacement pump 903. In this embodiment, the device 900 includes three sections of microfluidic channel 901a 901b 901c connected to the positive displacement pump 903. It will however be understood that in certain embodiments, the device 900 can include two, three, or more than three microfluidic channels connected to the positive displacement pump 903.

Each section of microfluidic channel 901a 901b 901c includes a corresponding valve 902a 902b 902c arranged to control the flow of fluid between the positive displacement pump 903 and the respective channel.

The device 900 also differs from the device shown in FIG. 1 in that the positive displacement pump 903 includes a single port 904. Depending on the configuration of the valves, the port 904 can operate as a fluid inlet or a fluid outlet. More particularly, with the microfluidic channel valves 902a 902b 902c closed and the fluid reservoir valve 905 open, the port 904 operates as a fluid inlet to allow fluid to re-fill the positive displacement pump 903. With fluid reservoir valve 905 closed and one (or more) of the microfluidic channel valves 902a 902b 902c open, the port 904 operates as a fluid outlet as fluid is forced out of the positive displacement pump 903 and into one or more of the microfluidic channels 901a 901b 901c to cause fluid to move along the channels.

Advantageously, in this way, a single positive displacement pump and associated fluid reservoir 906 can be used to move fluid through multiple microfluidic channels. This can further reduce the footprint of the device 900.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

What is claimed

1. A microfluidic device comprising:
a microfluidic channel;
a positive displacement pump comprising a chamber fluidically connected to the microfluidic channel, wherein the positive displacement pump is configured such that when the positive displacement pump is actuated, fluid within the chamber is displaced into the microfluidic channel; and
a fluid reservoir fluidically connected to the chamber of the positive displacement pump to provide a source of fluid to re-fill the chamber after the positive displacement pump has been actuated, wherein the fluid reservoir is configured such that fluid within the reservoir is sealed within the microfluidic device, wherein the fluid reservoir comprises a fluid storage chamber of the microfluidic device and the fluid storage chamber is a waste chamber configured to store waste liquid on the microfluidic device, wherein the microfluidic device comprises a fluid loop configured for providing a continuous fluid flow channel between the microfluidic channel and the positive displacement pump, wherein the fluid storage chamber is connected such that it forms part of the continuous fluid flow channel, wherein the fluid storage chamber comprises:
a first and a further fluid storage chamber port via which the fluid storage chamber is connected to the continuous fluid flow channel, wherein the first and further fluid storage chamber ports are hollow spikes that extend into the fluid storage chamber above a base surface of the fluid storage chamber such that liquid can be stored within the fluid storage chamber below the level of the first and further fluid storage chamber ports.

2. The microfluidic device as claimed in claim 1, wherein the microfluidic device further comprises a first valve configured to selectively control a flow of fluid between the chamber of the positive displacement pump and the microfluidic channel, and a second valve configured to selectively control a flow of fluid between the chamber of the positive displacement pump and the fluid reservoir.

3. The microfluidic device as claimed in claim 2, wherein at least one of the first and second valves are externally actuatable.

4. The microfluidic device as claimed in claim 1, wherein the fluid reservoir comprises an oversized portion of microfluidic channel adjacent to a port of the positive displacement pump.

5. The microfluidic device as claimed in claim 1, wherein the positive displacement pump is a bellows pump.

6. The microfluidic device as claimed in claim 5, wherein the chamber of the bellows pump is configured to be resiliently deformable.

7. The microfluidic device as claimed in claim 1, wherein the microfluidic device is a microfluidic cassette.

8. A method of moving fluid through a microfluidic channel of a microfluidic device, the method comprising:
actuating a positive displacement pump of a microfluidic device such that fluid within a chamber of the positive displacement pump is displaced into a microfluidic channel thereby causing fluid to move through the microfluidic channel; and
re-filling the chamber of the positive displacement pump from a source of fluid provided by a fluid reservoir of the microfluidic device, the fluid reservoir configured such that fluid within the reservoir is sealed within the microfluidic device, wherein the fluid reservoir comprises a fluid storage chamber of the microfluidic device and the fluid storage chamber is a waste chamber configured to store waste liquid on the microfluidic device, wherein the microfluidic device comprises a fluid loop configured for providing a continuous fluid flow channel between the microfluidic channel and the positive displacement pump, wherein the fluid storage chamber is connected such that it forms part of the continuous fluid flow channel, wherein the fluid storage chamber comprises:
a first and a further fluid storage chamber port via which the fluid storage chamber is connected to the continuous fluid flow channel, wherein the first and further fluid storage chamber ports are hollow spikes that extend into the fluid storage chamber above a base surface of the fluid storage chamber such that liquid can be stored within the fluid storage chamber below the level of the first and further fluid storage chamber ports.

9. The method as claimed in claim 8, the microfluidic device further comprising a first valve configured to selectively control the flow of fluid between the chamber of the positive displacement pump and the microfluidic channel, and a second valve configured to selectively control the flow of fluid between the chamber of the positive displacement pump and the fluid reservoir.

10. The method as claimed in claim 9, wherein the method further comprises:
closing the second valve and opening the first valve prior to actuating the positive displacement pump; and
closing the first valve and opening the second valve prior to re-filling the chamber.
